(19) United States
(12) Patent Application Publication
(10) Pub. No.: US 2025/0282433 A1
(43) Pub. Date: Sep. 11, 2025

(54) SHOCK ABSORBER ATTACHMENT JIG

(71) Applicant: Toyota Motor Engineering & Manufacturing North America, Inc., Plano, TX (US)

(72) Inventors: Samuel Garrigus Reshad, Newburgh, IN (US); Chase O. Muncy, Haubstadt, IN (US); Justin Wayne Ice, Hazleton, IN (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/595,886

(22) Filed: Mar. 5, 2024

(51) Int. Cl. B62D 65/02

(52) U.S. Cl. CPC B62D 65/026

(57) ABSTRACT

A shock absorber attachment jig includes a cap including a body portion and a flap extending from the body portion, and a fastener-receiving sub-assembly structured to be attached to the flap. The flap is structured to be rotatable with respect to the body portion so as to enable rotation of the sub-assembly with respect to the cap body portion when the sub-assembly is attached to the flap. When attached to a shock absorber, the jig enables movement of a fastener received in the sub-assembly into an assembly orientation of the fastener, thereby facilitating application of the fastener to the shock absorber and a vehicle body to attach the shock absorber to the body.

### TECHNICAL FIELD

The present invention relates to jigs used for assembly of vehicles and, more particularly, to a jig used for attaching a portion of a shock absorber to a vehicle body during vehicle assembly.

### BACKGROUND

An ongoing problem in assembly of motor vehicles is limited physical access of assembly personnel to confined or restricted spaces between portions of the vehicle. It is often time-consuming and physically very difficult to properly position, orient, and apply mechanical fasteners where and when they are needed to attach vehicle components to each other. It may also be difficult for a user to actually see into the area where the fasteners are to be applied. In particular, due to the structure of a vehicle body in the area where a shock absorber is to be attached to the body, and the need to attach other components to the vehicle frame and body prior to attaching the shock absorber to the vehicle, it may be very difficult to attach a shock absorber to the vehicle body at a designated attachment location during vehicle assembly.

### SUMMARY

In one aspect of the embodiments described herein, a shock absorber attachment jig is provided for attaching a portion of a shock absorber to a vehicle. The jig includes a cap including a body portion and a flap extending from the body portion, and a fastener-receiving sub-assembly structured to be attached to the flap. The flap is structured to be rotatable with respect to the body portion so as to enable rotation of the sub-assembly with respect to the cap body portion when the sub-assembly is attached to the flap.

### BRIEF DESCRIPTION OF THE DRAWINGS

The accompanying drawings, which are incorporated in and constitute a part of the specification, illustrate various systems, methods, and other embodiments of the disclosure. In some embodiments, one element may be designed as multiple elements or multiple elements may be designed as one element. In some embodiments, an element shown as an internal component of another element may be implemented as an external component and vice versa. Furthermore, elements may not be drawn to scale. Also, unless otherwise stated or shown, the same or similar elements shown in different views may be given the same or similar reference numerals or designations.

FIG. 1 is a schematic perspective view of a shock absorber attachment jig in accordance with an embodiment described herein, shown attached to a vehicle during assembly of the vehicle.

FIG. 2 is a schematic exploded view of the shock absorber attachment jig shown in FIG. 1.

FIG. 3 is a schematic side perspective view of a bracing portion of the shock absorber attachment jig shown in FIG. 1.

FIG. 4 is a schematic bottom perspective view of a connecting element of the shock absorber attachment jig shown in FIG. 1.

FIG. 5 is a schematic perspective view of an extender guide of the shock absorber attachment jig shown in FIG. 1.

FIG. 6 is a schematic perspective view of a portion of a fastener-receiving sub-assembly of the shock absorber attachment jig shown in FIG. 1.

FIGS. 7A-7C are schematic side views showing attachment of the shock absorber attachment jig to a shock absorber and rotation of the fastener-receiving sub-assembly to move a fastener into an assembly orientation of the fastener for application of the fastener to the shock absorber and a shock tower of a vehicle.

### DETAILED DESCRIPTION

A shock absorber attachment jig includes a cap including a body portion and a flap extending from the body portion, and a fastener-receiving sub-assembly structured to be attached to the flap. The flap is structured to be rotatable with respect to the body portion so as to enable rotation of the sub-assembly with respect to the cap body portion when the sub-assembly is attached to the flap. When attached to a shock absorber, the jig enables movement of a fastener received in the sub-assembly into an assembly orientation of the fastener, thereby facilitating application of the fastener to the shock absorber and a vehicle body to attach the shock absorber to the body.

The various elements set forth in the following description may be fabricated from any material or materials (e.g., metals, polymers, etc.) suitable for the purposes described herein. Also, if desired, suitable threaded metallic inserts may be secured in any of the components described herein to facilitate the use of threaded fasteners attaching and securing the components to each other.

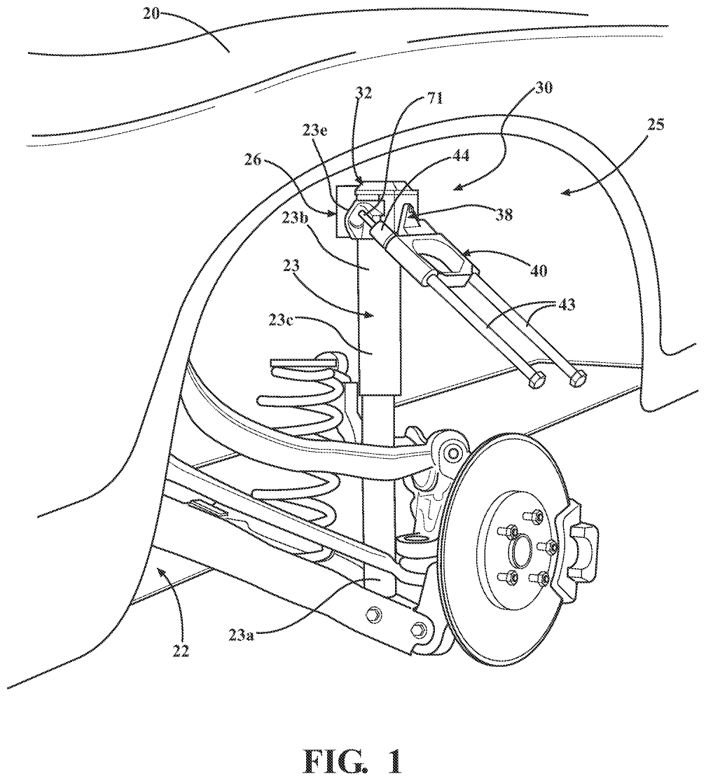

FIG. 1 is a schematic perspective view of a shock absorber attachment jig 30 in accordance with an embodiment described herein, shown attached to a vehicle 20 during assembly of the vehicle. Vehicle 20 may include a frame 22 and a body 25 configured for mounting on the frame 22 during vehicle assembly.

Referring to FIG. 1, as known in the pertinent art, a shock tower 26 may be attached to the vehicle body 25 to provide an attachment point for an upper end of a suspension damper, such as a shock absorber 23. The shock tower 26 may include one or more threaded holes into which fastener(s) may be inserted to secure attachment ears 23e of the shock absorber 23 to the shock tower 26, thereby mounting the shock absorber 23 to the vehicle body 25.

The shock absorber 23 may have a first end 23a, a second end 23b opposite the first end 23a, and a longitudinal body 23c extending between the first and second ends. The first end 23a may be a lower end of the shock absorber 23 when the shock absorber 23 is coupled to an associated axle or other portion of the vehicle mounted to the frame 22. The second end 23b may be an upper end of the shock absorber 23 when the second end 23b is connected to the shock tower 26.

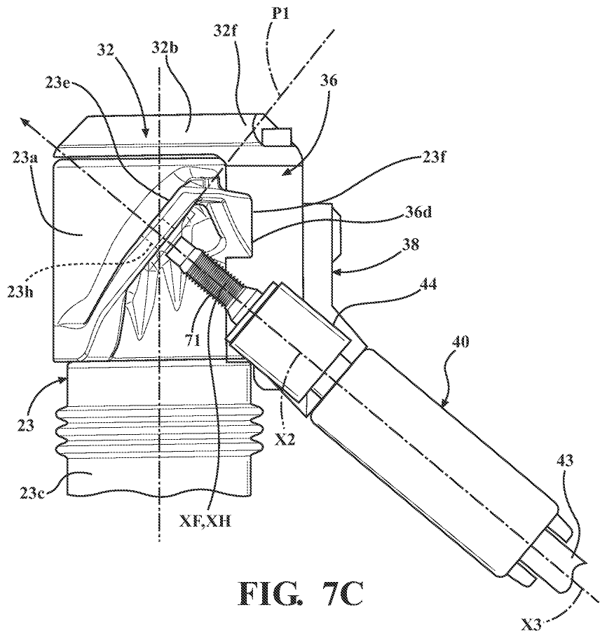

Referring to FIGS. 1 and 7A-7C, one or more attachment ears 23e may extend outwardly from the shock absorber body 23c. Each attachment ear 23e may have a through-hole 23h extending therethrough to enable attachment of the attachment ear 23e to the shock tower 26 using mechanical fasteners as described herein. Where a pair of ears 23e are used as shown in FIGS. 1 and 7A-7C, the ears may extend from opposite sides of the shock absorber body 23c so that surfaces of the ears 23e including openings into the through-holes 23h in a direction DI toward the vehicle body 25 are coplanar (within applicable tolerance limits) along a plane P1. A flange 23f may also extend along an exterior of the shock absorber body 23c between the attachment ears 23e.

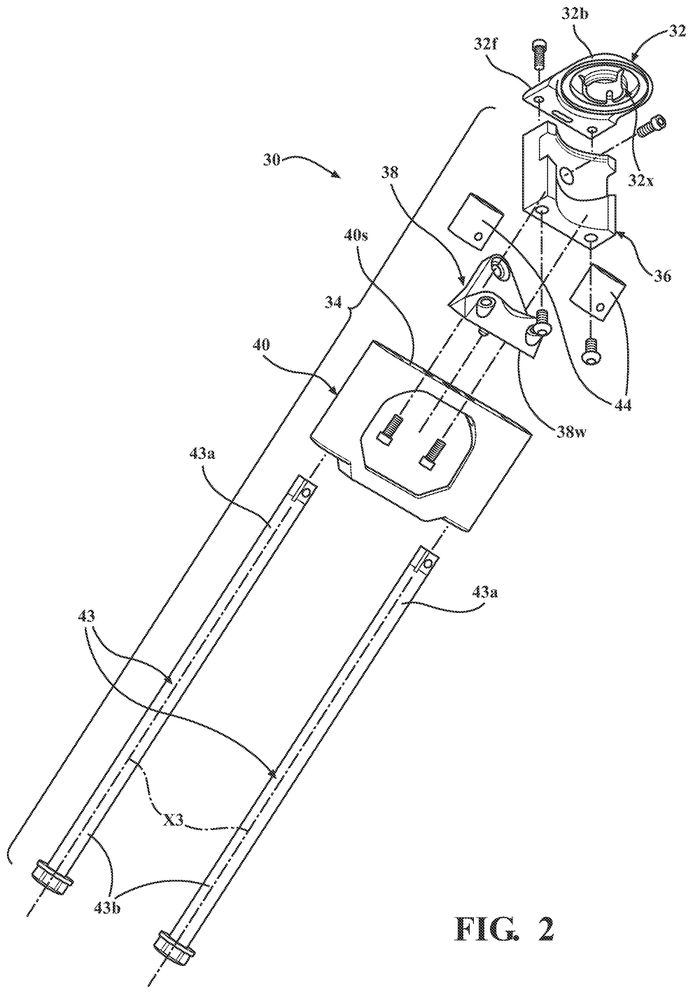

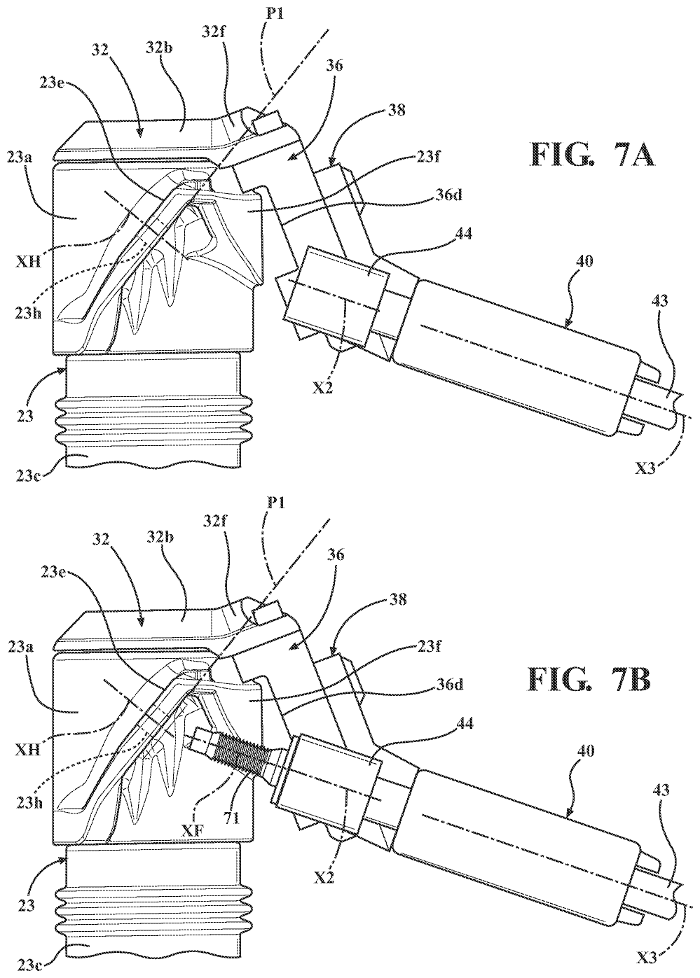

FIG. 2. is a schematic exploded view of the shock absorber attachment jig 30 shown in FIG. 1. Referring to FIGS. 1 and 2, the jig 30 may include a cap 32 structured for attachment to the shock absorber 23 at or near an upper end 23b of the shock absorber. Cap 32 may include a body portion 32b and a flap 32f extending from (and formed integrally with) the body portion 32b. In particular arrangements, as shown in FIGS. 1 and 6, the cap body portion 32b may incorporate attachment features (generally designated 32x) structured to form an interference fit with features (not shown) already present on the upper end 23b of the shock absorber 23, thereby securing the cap 32 to the shock absorber 23 until the shock absorber is attached to the vehicle body 25 using mechanical fasteners as described herein.

The flap 32f may incorporate tabs, holes, and/or other features enabling additional elements of the shock absorber attachment jig to be attached to the cap 32 as described herein. The cap 32 may be formed from a relatively flexible material so as to enable bending of the cap flap 32f with respect to the cap body portion 32b as described herein. Materials suitable for the cap 32 may have characteristics of both plastic and rubber. Examples of such materials include melt-processable thermoplastic elastomers such as various durometers of thermoplastic polyurethane (TPU). The cap 32 may be formed from any material suitable for the purposes described herein.

Referring to the drawings, the jig 30 may also include a fastener-receiving sub-assembly (generally designated 34) structured to be attachable to the cap flap 32f. The fastener-receiving sub-assembly 34 may be structured to hold to mechanical fasteners 71 that will be used to attach the shock absorber 23 to the vehicle body 25, and to maintain each fastener 71 in an assembly orientation of the fastener as described herein, when the jig 30 is mounted on the shock absorber 23 by attaching the cap 32 to the shock absorber.

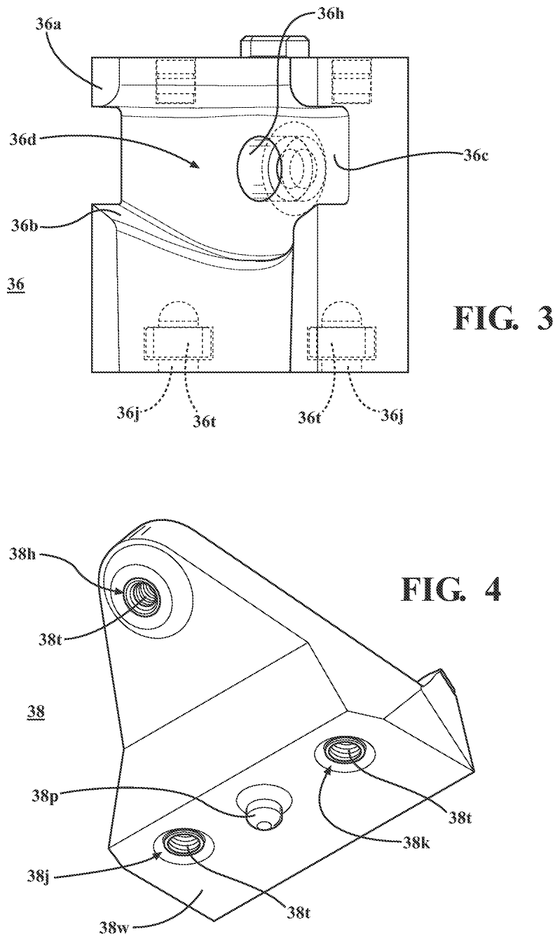

Referring to FIGS. 1 and 3, the fastener-receiving sub-assembly 34 may include a bracing portion 36 structured to be attachable to the cap flap 32f. The bracing portion 36 may include a first shoulder 36a, a second shoulder 36b positioned opposite the first shoulder 36a, and a connecting wall 36c extending between and connecting the first and second shoulders 36a, 36b. In combination, the first shoulder 36a, the second shoulder 36b and the connecting wall 36c may define a cavity 36d structured to receive the shock absorber flange 23f therein when the jig 30 is attached to the shock absorber 23 as described herein.

In particular arrangements, the cavity 36d may be structured so that the first and second shoulders 36a, 36b form a slight interference fit with portions of the flange 23f when the flange is received in the cavity 36d and the second shoulder 36b is in physical contact with the shock absorber body 23c adjacent the flange 23f. This may help retain the first and second shoulders 36a, 36b in contact with the shock absorber body 23c during movement of the shock absorber 23, when the cap 32 is mounted on the shock absorber 23.

Holes 36h (in the connecting wall 36c) and 36j (in the second shoulder 36b) may be provided to enable attachment of a connecting element 38 (described below) to the bracing portion 36, using threaded fasteners for example. Suitable metallic threaded inserts 36t may be pressed in, molded in, or otherwise secured in the holes 36h and 36j to facilitate use of threaded fasteners for connection.

The bracing portion 36 may be formed from a relatively rigid material, such as a suitable polymer, for example. The bracing portion 36 may be formed using any suitable method, such as molding or 3-D printing, for example.

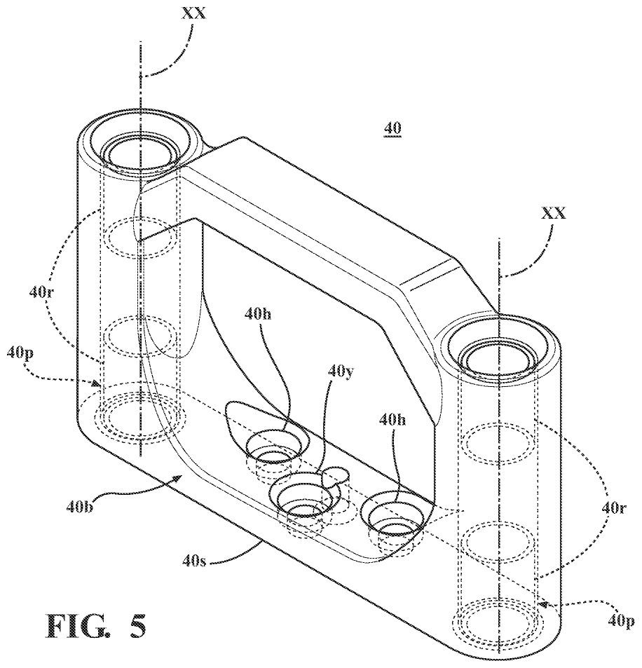

Referring to FIGS. 1 and 4, the fastener-receiving sub-assembly 34 may include a connecting element 38 structured to connect the bracing portion and an extender guide 40 (described below). The connecting element 38 may be structured to be attachable to the bracing portion 36 by a fastener applied in a first connecting element hole 38h and bracing portion hole 36h. A fastener is “applied” when it is inserted into suitable hole(s) in one or more components to be connected or attached to each other by the fastener, and/or when the fastener is rotated or otherwise manipulated so as to secure the components together. A suitable metallic threaded insert 38t may be pressed, molded, or otherwise secured in the connecting element hole 38h to facilitate use of a threaded fastener for connection. Similarly, threaded inserts 38t may be pressed, molded, or otherwise secured in second and third connecting portion holes 38j, 38k to facilitate use of a threaded fastener for the extender guide 40 to the connecting element 38.

Connecting element 38 may include a bearing surface 38w structured to abut and support the extender guide 40 in a predetermined orientation with respect to the bracing portion 36 when the extender guide 40 is attached to the connecting element 38 and the cap 32 is attached to the shock absorber 23 as described herein. A locating pin 38p may extend from the bearing surface 38w to aid in positioning the extender guide 40 with respect to the connecting element 38 for purposes of assembling the fastener-receiving sub-assembly 34. The connecting element 38 may be formed from a relatively rigid material, such as a suitable polymer, for example.

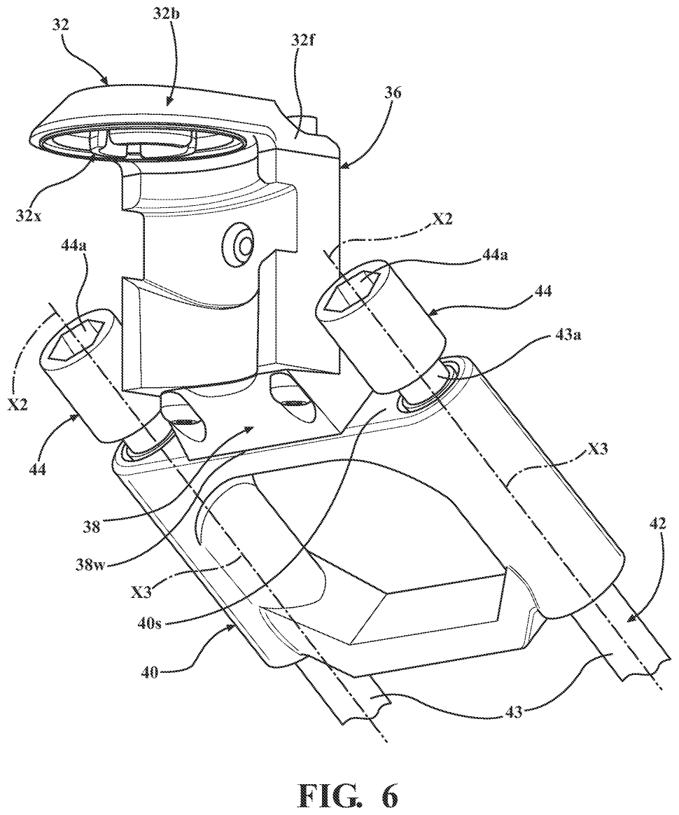

Referring to FIGS. 1 and 5, the fastener-receiving sub-assembly 34 may include the extender guide 40. The extender guide 40 may be structured to be attachable to the connecting element 38 using fasteners or other methods. The extender guide 40 may be structured to rotatably support one or more extenders 43 (described below) usable to rotate the threaded fasteners 71 that secure the shock absorber second end 23b to the shock tower 26.

In one or more arrangements, the extender guide 40 may include a base portion 40b and one or more extender passages 40p formed in the base portion 40b. Each extender passage 40p may have a central axis XX. The example shown in the drawings includes a pair of extender passages 40p formed therein. The extender passages 40p may include sleeve bearings 40r mounted therein to facilitate rotation of the portions of extenders 43 residing inside the passages 40p.

The extender guide 40 may include a bearing surface 40s structured to abut and support the connecting element 38 when the extender guide 40 is attached to the connecting element. The extender guide 40 may be attached to the connecting element 38 using threaded fasteners or any other suitable method. The extender guide base portion 40b may include through holes 40h enabling attachment of the extender guide 404 to the connecting element 38 using threaded fasteners. The extender guide base portion 40b may also include a hole 40y structured to receive therein the locating pin 38p of connecting element 38, to aid in positioning the extender guide 40 with respect to the connecting element 38. The extender guide 40 may be formed from a relatively rigid material, such as a suitable polymer, for example.

Referring to FIGS. 1 and 6, the fastener-receiving sub-assembly 34 may include at least one extender assembly 42. In the examples described herein, the fastener-receiving sub-assembly 34 includes a pair of extender assemblies 42. Each extender assembly 42 may be structured to be rotatably supported by the extender guide 40 in an associated one of extender passages 40p.

Each extender assembly 42 may include an extender 43. Each extender 43 may be cylindrical and may have a first end 43a, a second end 43b opposite the first end, and a body 43c extending between and connecting the first and second ends 43a, 43b. Each extender 43 may have a longitudinal central axis X3. In some arrangements, the extender 43 may be a cylindrical rod formed from a suitable material (e.g., aluminum). Each extender 43 and the extender guide 40 may be structured so that the extender is rotatable within, and axially slidable along, an interior of an associated extender passage 40p of the extender guide 40.

Referring to FIGS. 1 and 6, each extender assembly 42 may include a socket 44 defining an interior cavity 44a having a central axis X2 and structured for receiving a fastener 71 therein. Each socket 44 may be structured to be attachable to a first end 43a of an associated extender 43 so as to rotate in correspondence with the extender 43 (i.e., a fastener 71 received in the socket 44 will rotate simultaneously with, and by the same amount as, the socket). Each socket may be structured to be attachable to an end of an associated extender 43 so that a central axis X2 of its socket cavity 44a is coaxial (within applicable tolerance limits) with a central axis X3 of the associated extender.

To enable the fastener 71 to be rotated by the socket 44 and in correspondence with the socket, the socket interior cavity 44a may be shaped to conform to a geometry of the fastener 71 to be received in the cavity 44a. Each cavity 44a may be structured so that a central axis XF of a fastener 71 received in the cavity will be coaxial (within applicable tolerance limits) with the central axis X2 of the cavity 44a. In one or more arrangements, the socket 44 and the fastener 71 to be received in the socket may be structured so that the fastener 71 forms a close sliding fit with walls of the fastener receiving cavity 44a. In some arrangements, the sockets 44 may be magnetized for retaining any fasteners 71 received in the socket cavities 44a.

In embodiments described herein, the fastener-receiving sub-assembly 34 may be structured to be rotatable with respect to the cap body portion 32b so as to enable movement of at least one fastener 71 received in the sub-assembly 34 into an assembly orientation of the fastener 71 when the sub-assembly 34 is attached to the cap flap 32f and the cap body portion 32b is attached to a shock absorber 23. An assembly orientation of the fastener 71 may be an orientation of the fastener with respect to the shock absorber in which fastener 71 need only be driven some distance along a central, longitudinal axis XF of the fastener toward a respective attachment ear 23e to apply the fastener to the shock absorber, when attaching the shock absorber 23 to the vehicle body. The assembly orientation of a fastener 71 may be achieved when a central axis XF of the fastener is coaxial (within applicable tolerance limits) with the central axis XH of a through hole 23h of an associated shock absorber attachment ear 23e, and the central axis XF of the fastener 71 is perpendicular (within applicable tolerance limits) to the plane P1 of the attachment ears. Referring to FIG. 7C, to aid in achieving and maintaining the fasteners 71 in their respective assembly orientations, the bracing portion 36, connecting element 38, and extender guide 40 may be structured so that the central axis XX of each extender guide passage extends coaxially (within applicable tolerance limits) with a central axis XX of an associated through hole 23h of the shock absorber attachment ear 23e when the bracing portion 36, connecting element 38, and extender guide 40 are structured and attached to each other as described herein, when the fastener-receiving sub-assembly 34 is attached to the cap flap 32f and the cap body portion 32b is attached to a shock absorber 23 as described herein, and when at least the bracing portion second shoulder 36b is rotated so as to be in physical contact with the shock absorber body 23c.

Operation of the shock absorber attachment jig 30 will now be discussed with reference to the drawings.

Referring to FIGS. 6 and 7A-7C, with the fastener-receiving sub-assembly 34 attached to the cap flap 32f as shown in FIG. 6, and after the shock absorber 23 has been connected to an associated wheel axle or another portion of the vehicle frame 22 as shown in FIG. 1, the cap body portion 32b of the jig 30 may be applied to the second end 23b of the shock absorber as previously described. Because the cap 32 is formed from a relatively flexible material, the cap flap 32f and the attached fastener-receiving sub-assembly 34 may be rotated away from the shock absorber body 23c (FIG. 7A) as the cap body portion 32b is applied to the shock absorber 23. After the cap body portion 32b is attached to the shock absorber 23, a fastener 71 may be inserted into each of socket cavities 44a (FIG. 7B) for attachment of the shock absorber to the shock tower. The fastener-receiving sub-assembly 34 may then be released so that it drops into a position where the bracing portion first and second shoulders 36a, 36b come into physical contact with the shock absorber body 23c, with the shock absorber flange 23f received in the bracing portion cavity 36d (FIG, 7C). Alternatively, the fastener-receiving sub-assembly 34 may be manually rotated toward the shock absorber body 23c until at least the bracing portion second shoulder 36b physically contact the shock absorber body 23c, with the shock absorber flange 23f engaging extending into the bracing portion cavity 36d and engaging surface(s) of the bracing portion 36 in an interference fit to maintain the bracing portion second shoulder 36b in physical contact with the shock absorber body 23c. This process orients the socket cavities 44a so that the fasteners 71 received in the socket cavities will be in their respective assembly orientations when the fasteners are positioned in the cavities.

Referring to FIGS. 1 and 7C, to attach the shock absorber 23 to the shock tower 26, the vehicle frame 22 and body 25 may be positioned with respect to each other so that the shock absorber attachment ear holes 23h and the fasteners 71 in the sockets 44 are aligned with associated threaded fastener-receiving holes in the shock tower 26. if needed, the shock absorber 23 may be pivoted about its first end 23a previously attached to the vehicle frame 22, to move the shock absorber second end 23b into a position where the fasteners 71 are in a position ready for the fasteners 71 to be applied to the shock tower 26. An impact driver or other suitable tool (not shown) may then be applied to the second end 43b of each extender 43 to rotate the extender assembly 42 while moving the extender assembly in a direction DI toward the shock tower 26, until the fasteners 71 extend through the attachment ear holes 23h and into the shock tower 26. The shock absorber attachment jig 30 may then be removed from the shock absorber.

Embodiments of the shock absorber attachment jig described herein may enable the threaded fasteners used to attach the shock absorber to the vehicle body to be positioned and secured in an orientation where they may be conveniently aligned for application to the shock absorber and shock tower by simple rotation of an end of the shock absorber.

In the above detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A shock absorber attachment jig comprising:
a cap including a body portion and a flap extending from the body portion; and
a fastener-receiving sub-assembly structured to be attached to the flap,
wherein the flap is structured to be rotatable with respect to the body portion so as to enable rotation of the sub-assembly with respect to the cap body portion when the sub-assembly is attached to the flap.

2. The shock absorber attachment jig of claim 1, wherein the sub-assembly is structured to be rotatable with respect to the cap body portion so as to enable movement of a fastener received in the sub-assembly to an assembly orientation of the fastener when the sub-assembly is attached to the flap and the cap body portion is attached to a shock absorber.

3. The shock absorber attachment jig of claim 1, wherein the sub-assembly includes a bracing portion defining a cavity structured to receive therein a flange of a shock absorber.

4. The shock absorber attachment jig of claim 3, wherein the flap is structured to be rotatable to position the flange inside the cavity when the sub-assembly is attached to the flap and the cap body portion is attached to the shock absorber.

5. The shock absorber attachment jig of claim 3, wherein the bracing portion includes a first shoulder, a second shoulder opposite the first shoulder, and a wall connecting the first and second shoulders, the first shoulder, the second shoulder and the wall defining the cavity.

6. The shock absorber attachment jig of claim 2, wherein the sub-assembly includes a bracing portion structured to be rotatable into physical contact with the shock absorber, and wherein the jig is structured so that a fastener received in the sub-assembly resides in the assembly orientation when the sub-assembly is attached to the flap, the cap body portion is attached to a shock absorber, and the bracing portion is in physical contact with the shock absorber.

7. The shock absorber attachment jig of claim 2, wherein the sub-assembly includes:
an extender assembly structured to support the fastener; and
an extender guide structured to support the extender assembly so that the extender assembly is rotatable and axially movable within an associated extender cavity formed in the extender guide.
